(19) United States
(12) Patent Application Publication
(10) Pub. No.: US 2016/0274410 A1
(43) Pub. Date: Sep. 22, 2016

(54) DISPLAY DEVICE AND METHOD OF MANUFACTURING THE SAME

(71) Applicant: SAMSUNG DISPLAY CO., LTD., Yongin City (KR)

(72) Inventors: Dohyun JUNG, Suwon-si (KR); Ocksoo SON, Seoul (KR); Yanghee KIM, Yongin-si (KR); Jeanho SONG, Yongin-si (KR); Donggun OH, Osan-si (KR)

(21) Appl. No.: 14/842,484

(22) Filed: Sep. 1, 2015

(30) Foreign Application Priority Data
Mar. 17, 2015 (KR) 10-2015-0036634

(51) Int. Cl. G02F 1/1335; G02F 1/1362; G02F 1/1368

(52) U.S. Cl. CPC G02F 1/133516; G02F 1/1368; G02F 1/136286; G02F 1/136209; G02F 2001/136222; G02F 2001/136218

(57) ABSTRACT

A display device includes: a lower substrate including red, green, and blue pixel units; an upper substrate disposed opposite to the lower substrate; a liquid crystal layer interposed between the lower substrate and the upper substrate; a gate line and a data line disposed on the lower substrate; a thin film transistor connected to the gate line and the data line; red, green, and blue color filters disposed on the red, green, and blue pixel units on the thin film transistor, respectively, to be spaced apart from one another; a neutral color filter interposed between the red, green, and blue color filters and extending along the data line; and a pixel electrode disposed on the red, green, and blue color filters.

### CROSS-REFERENCE TO RELATED APPLICATION

This application claims priority to and the benefit of Korean Patent Application No. 10-2015-0036634, filed on Mar. 17, 2015, with the Korean Intellectual Property Office, the disclosure of which is incorporated herein in its entirety by reference.

### BACKGROUND

1. Field

Embodiments of the present disclosure relate to a display device and a method of manufacturing the same, and more particularly, to a display device in which a color filter and a thin film transistor are disposed on the same substrate and a method of manufacturing the same.

2. Description of the Related Art

Display devices may be classified into liquid crystal display (“LCD”) devices, organic light emitting diode (“OLED”) display devices, plasma display panel (“PDP”) devices, electrophoretic display (“EPD”) devices, and the like, based on their light emitting scheme.

An LCD device generally includes two substrates disposed opposite to one another, electrodes formed on the substrates, and a liquid crystal layer interposed between the substrates. Upon voltages being applied to the electrodes, liquid crystal molecules of the liquid crystal layer are rearranged, such that the amount of transmitted light is adjusted in the display device.

In general, an LCD device has a structure in which one of the two substrates includes a plurality of thin film transistors and a pixel electrode formed thereon, and the other substrate includes a plurality of color filters, a light shielding member, and a common electrode formed thereon. In recent times, however, in order to prevent an alignment error between the pixel electrode and the color filter, a color filter on array (COA) structure and a black matrix on array (BOA) structure in which a color filter, a light shielding member, a pixel electrode, and the like, other than a common electrode, are formed on the same substrate have been developed.

Nevertheless, a display device having such a structure may have an issue of relatively low outdoor readability.

It is to be understood that this background of the technology section is intended to provide useful background for understanding the technology disclosed herein. As such, the technology background section may include ideas, concepts or recognitions that are not part of what was known or appreciated by those skilled in the pertinent art prior to the effective filing date of the subject matter disclosed herein.

### SUMMARY

Aspects of embodiments of the present disclosure are directed to a display device capable of enhancing the readability thereof and a method of manufacturing the same.

According to an exemplary embodiment of the present disclosure, a display device includes: a lower substrate including red, green, and blue pixel units; an upper substrate disposed opposite to the lower substrate; a liquid crystal layer interposed between the lower substrate and the upper substrate; a gate line and a data line disposed on the lower substrate; a thin film transistor connected to the gate line and the data line; red, green, and blue color filters disposed on the red, green, and blue pixel units on the thin film transistor, respectively, to be spaced apart from one another; a neutral color filter interposed between the red, green, and blue color filters and extending along the data line; and a pixel electrode disposed on the red, green, and blue color filters.

The neutral color filter may include: a first neutral color filter interposed between the red color filter and the green color filter; a second neutral color filter interposed between the green color filter and the blue color filter; and a third neutral color filter interposed between the blue color filter and the red color filter.

The first neutral color filter may have a neutral color between the red color of the red color filter and the green color of the green color filter.

The second neutral color filter may have a neutral color between the green color of the green color filter and the blue color of the blue color filter.

The third neutral color filter may have a neutral color between the blue color of the blue color filter and the red color of the red color filter.

The first neutral color filter may have chromaticity coordinates (x, y) in a range of about (0.38˜0.48, 0.46˜0.56) in a CIE xy chromaticity diagram.

The second neutral color filter may have chromaticity coordinates (x, y) in a range of about (0.16˜0.17, 0.30˜0.40) in the CIE xy chromaticity diagram.

The third neutral color filter may have chromaticity coordinates (x, y) in a range of about (0.34˜0.44, 0.13˜0.23) in the CIE xy chromaticity diagram.

The display device may further include a planarization layer disposed on the red, green, and blue color filters and the neutral color filter.

The display device may further include a first light shielding member disposed on the planarization layer and extending along the gate line.

The display device may further include a second light shielding member disposed on the planarization layer and extending along the data line.

The display device may further include a shield electrode disposed on the neutral color filter and extending along the data line.

According to another exemplary embodiment of the present disclosure, a method of manufacturing a display device, the method includes: forming a thin film transistor on a lower substrate including red, green, and blue pixel units; forming red, green, and blue color filters to correspond to the red, green, and blue pixel units on the thin film transistor, respectively, to be spaced apart from one another; forming a neutral color filter interposed between the red, green, and blue color filters; and forming a pixel electrode on the red, green, and blue color filters.

The forming of the neutral color filter may include: forming a first neutral color filter between the red color filter and the green color filter; forming a second neutral color filter between the green color filter and the blue color filter; and forming a third neutral color filter between the blue color filter and the red color filter.

The first neutral color filter may be formed to have chromaticity coordinates (x, y) in a range of about (0.38˜0.48, 0.46˜0.56) in a CIE xy chromaticity diagram.

The second neutral color filter may be formed to have chromaticity coordinates (x, y) in a range of about (0.16˜0.17, 0.30˜0.40) in the CIE xy chromaticity diagram.

The third neutral color filter may be formed to have chromaticity coordinates (x, y) in a range of about (0.34˜0.44, 0.13˜0.23) in the CIE xy chromaticity diagram.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure will be more clearly understood from the following detailed description taken in conjunction with the accompanying drawings, in which:

FIG. 1 is a plan view schematically illustrating a display device according to an exemplary embodiment;

FIG. 2 is a cross-sectional view taken along line I-I′ of FIG. 1;

FIG. 3 is a CIE xy chromaticity diagram for illustrating a neutral color filter in a display device according to an exemplary embodiment;

FIG. 4 is a cross-sectional view illustrating a display device according to another exemplary embodiment; and

FIGS. 5A, 5B, 5C, 5D and 5E are cross-sectional views illustrating sequential processes of a method of manufacturing a display device according to an exemplary embodiment, respectively.

### DETAILED DESCRIPTION

Hereinafter, embodiments of the present disclosure are now described in more detail with reference to the accompanying drawings.

The present system and method may, however, be embodied in many different forms and should not be construed as being limited to the exemplary embodiments set forth herein. Rather, these exemplary embodiments are provided to help convey the scope of the present disclosure to those skilled in the art.

Throughout the specification, when an element is referred to as being “connected” to another element, the element may be “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first”, “second”, and the like, may be used herein to describe various elements, components, areas, layers and/or sections, these elements, components, areas, layers and/or sections are not limited by these terms. These terms are only used to distinguish one element, component, area, layer or section from another element, component, area, layer or section. Thus, a first element, component, area, layer or section discussed below may also be referred to as a second element, component, area, layer or section without departing from the teachings of example embodiments.

In the drawings, certain elements or shapes may be simplified or exaggerated to better illustrate the present system and method, and other elements present in an actual product may also be omitted. Thus, the drawings are intended to facilitate the understanding of the present disclosure. Like reference numerals refer to like elements throughout the specification.

Hereinafter, exemplary embodiments of a display device according to the present system and method are explained with respect to a liquid crystal display (“LCD”) device. However, the display device is not limited thereto, and features of the present system and method may also be applied to an organic light emitting diode (“OLED”) display device.

In addition, exemplary embodiments of the display device according to the present system and method are explained with respect to a color filter on array (COA) structure and a black matrix on array (BOA) structure in which a thin film transistor, a color filter, and a light shielding member are disposed on the same substrate.

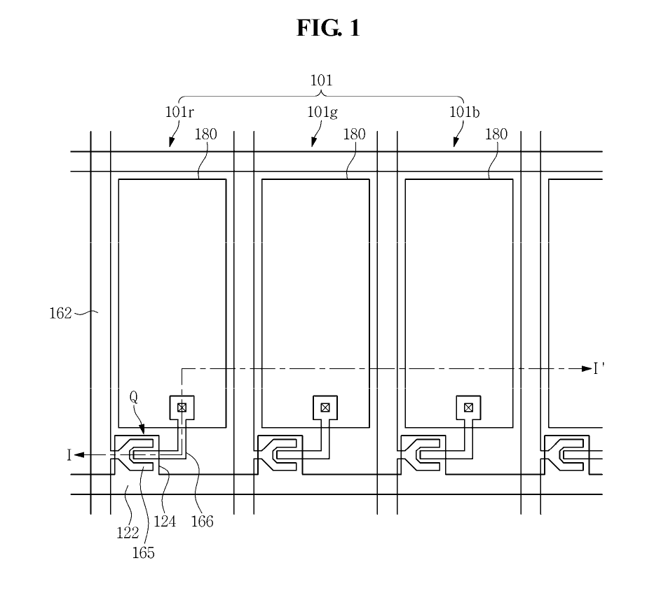

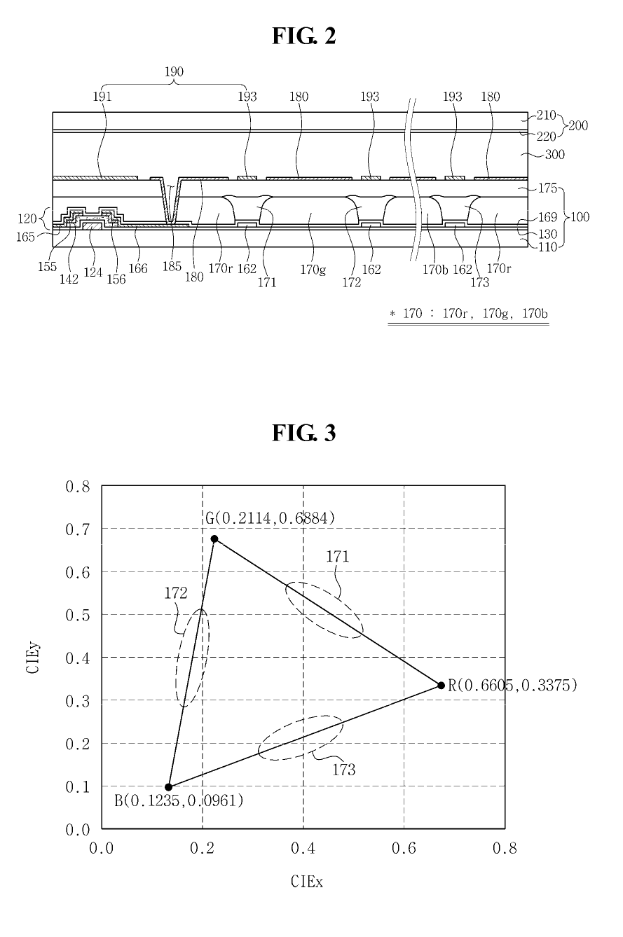

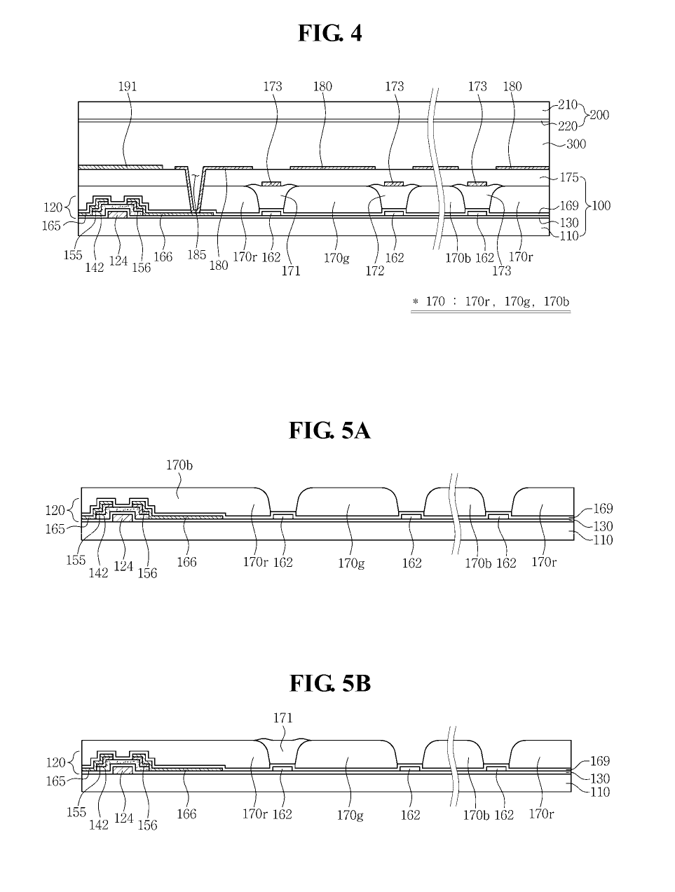

FIG. 1 is a plan view schematically illustrating a display device according to an exemplary embodiment. FIG. 2 is a cross-sectional view taken along line IT of FIG. 1. FIG. 3 is a CIE xy chromaticity diagram for illustrating a neutral color filter in a display device according to an exemplary embodiment. FIG. 4 is a cross-sectional view illustrating a display device according to another exemplary embodiment.

Referring to FIGS. 1 and 2, a display device according to an exemplary embodiment may include a lower panel 100, an upper panel 200 disposed opposite to the lower panel 100, and a liquid crystal layer 300 interposed between the lower panel 100 and the upper panel 200.

The lower panel 100 may include a lower substrate 110 in which a plurality of pixel units 101 including red, green, and blue pixel units 101r, 101g, and 101b are arranged in a matrix form, a layer structure 120 disposed on the lower substrate 110 and including a thin film transistor, red, green, and blue color filters 170r, 170g, and 170b disposed on the layer structure 120 to be spaced apart from one another, neutral color filters 171, 172, and 173 interposed between the red, green, and blue color filters 170r, 170g, and 170b, a planarization layer 175 disposed on the red, green, and blue color filters 170r, 170g, and 170b and the neutral color filters 171, 172, and 173, and a pixel electrode 180 and a light shielding member 190 that are disposed on the planarization layer 175. Hereinafter, the red, green, and blue color filters 170r, 170g, and 170b are collectively referred to as a color filter 170.

The lower substrate 110 may include an insulating substrate formed of transparent glass such as soda lime glass or borosilicate glass, plastic, or the like.

Gate wirings 122 and 124 transmitting a gate signal may be disposed on the lower substrate 110. The gate wirings 122 and 124 may include a gate line 122 extending in a direction, for example, a horizontal direction, and a gate electrode 124 protruding from the gate line 122 to form a protrusion. The gate electrode 124, along with a source electrode 165 and a drain electrode 166, may constitute a three-terminal structure of a thin film transistor Q.

Although not illustrated, a storage wiring for forming the pixel electrode 180 and a storage capacitor may further be formed on the lower substrate 110. The storage wiring (not illustrated) may be formed simultaneously with the gate wirings 122 and 124, may be disposed on the same layer on which the gate wirings 122 and 124 are disposed, and may be formed of the same material for forming the gate wirings 122 and 124.

The gate wirings 122 and 124 may be formed of an aluminum (Al) based metal such as Al or an Al alloy, a silver (Ag) based metal such as Ag or an Ag alloy, a copper (Cu) based metal such as Cu or a Cu alloy, a molybdenum (Mo) based metal such as Mo or a Mo alloy, chromium (Cr), titanium (Ti), tantalum (Ta), or the like.

In addition, the gate wirings 122 and 124 may have a multilayer structure including two conductive layers (not illustrated) having different physical properties.

One of the two conductive layers (not illustrated) may be formed of a metal having low resistivity, for example, an Al based metal, an Ag based metal, or a Cu based metal, so that a signal delay or a voltage drop of the gate wirings 122 and 124 may be reduced.

The other of the two conductive layers (not illustrated) may be formed of a material having an excellent contact property with another material, more particularly, with indium tin oxide (ITO) and indium zinc oxide (IZO). Examples of such a material may include a Mo based metal, Cr, Ti, Ta, or the like.

By way of example, the two conductive layers of the multilayer structure may include a Cr lower layer and an Al upper layer, an Al lower layer and a Mo upper layer, and a Ti lower layer and a Cu upper layer. However, the material for forming the gate wirings 122 and 124 is not limited thereto, and the gate wirings 122 and 124 may be formed of various metals and conductive materials.

A gate insulating layer 130 may be disposed on the lower substrate 110 and the gate wirings 122 and 124. The gate insulating layer 130 may include SiOₓ or SiNₓ. In addition, the gate insulating layer 130 may further include aluminum oxide, titanium oxide, tantalum oxide, or zirconium oxide.

A semiconductor layer 142 for forming a channel of the thin film transistor Q may be disposed on the gate insulating layer 130 to overlap at least the gate electrode 124. The semiconductor layer 142 may be formed of amorphous silicon (also referred to as “a-Si”), or an oxide semiconductor including at least one element selected from gallium (Ga), indium (In), tin (Sn), and zinc (Zn).

Ohmic contact layers 155 and 156 may be disposed on the semiconductor layer 142. The ohmic contact layers 155 and 156 may serve to enhance a contact property between the source electrode 165 and/or the drain electrode 166, which are to be described further below, and the semiconductor layer 142.

In this instance, the ohmic contact layers 155 and 156 may be formed of amorphous silicon doped with n-type impurities at high concentration (also referred to as “n+a-Si”). In a case in which the contact property between the source electrode 165 and/or the drain electrode 166 and the semiconductor layer 142 is sufficiently secured, the ohmic contact layers 155 and 156 may be omitted in the present exemplary embodiment.

Data wirings 162, 165, and 166 may be disposed on the ohmic contact layers 155 and 156 and the gate insulating layer 130. The data wirings 162, 165, and 166 include a data line 162, the source electrode 165, and the drain electrode 166. The data line 162 may be formed in a direction intersecting the gate line 122, for example, a vertical direction, and defining the pixel unit 101 along with the gate line 122. The source electrode 165 may branch out from the data line 162 to extend onto the semiconductor layer 142. The drain electrode 166 may be spaced apart from the source electrode 165 and formed on the semiconductor layer 142 disposed opposite to the gate electrode 124 based on the source electrode 165 or a channel area of the thin film transistor Q. In this instance, as FIG. 1 shows, the drain electrode 166 may extend from an upper portion of the semiconductor layer 142 to a lower portion of the pixel electrode 180.

A protection layer 169 may be disposed over a structure formed by the data wirings 162, 165, and 166. The protection layer 169 may have a monolayer structure or a multilayer structure including, for example, silicon oxide, silicon nitride, a photosensitive organic material, or a low dielectric constant (low K) insulating material such as a-Si:C:O or a-Si:O:F.

The structure of the thin film transistor Q described hereinbefore with reference to FIGS. 1 and 2 is only given by way of example, and the layer structure 120 including the thin film transistor Q may be modified in various manners.

The plurality of color filters 170 including the red color filter 170r, the green color filter 170g, and the blue color filter 170b may be disposed on the layer structure 120.

The red color filter 170r, the green color filter 170g, and the blue color filter 170b may be disposed to correspond to the red pixel unit 101r, the green pixel unit 101g, and the blue pixel unit 101b, respectively.

The red color filter 170r, the green color filter 170g, and the blue color filter 170b may be disposed in a vertically (vertical orientation as shown in FIG. 1) elongated stripe form so as to correspond to the red pixel unit 101r, the green pixel unit 101g, and the blue pixel unit 101b, respectively.

The neutral color filters 171, 172, and 173 may be interposed between the red, green, and blue color filters 170r, 170g, and 170b. In addition, the neutral color filters 171, 172, and 173 may extend along the data line 162.

The neutral color filters 171, 172, and 173 may include a first neutral color filter 171 interposed between the red color filter 170r and the green color filter 170g, a second neutral color filter 172 interposed between the green color filter 170g and the blue color filter 170b, and a third color filter 173 interposed between the blue color filter 170b and the red color filter 170r.

The neutral color according to the exemplary embodiment may be defined based on a CIE xy chromaticity system established by the International Commission on Illumination (CIE). For example, referring to FIG. 3, in a case in which the red color filter 170r has chromaticity coordinates represented by Rxy=(0.6605, 0.3375), the green color filter 170g has chromaticity coordinates represented by Gxy=(0.2114, 0.6884), and the blue color filter 170b has chromaticity coordinates represented by Bxy=(0.1235, 0.0961), the first neutral color filter 171 may have chromaticity coordinates (x, y) in a range of about (0.38˜0.48, 0.46˜0.56), the second neutral color filter 172 may have chromaticity coordinates (x, y) in a range of about (0.16˜0.17, 0.30˜0.40), and the third neutral color filter 173 may have chromaticity coordinates (x, y) in a range of about (0.34˜0.44, 0.13˜0.23) in a CIE xy chromaticity diagram.

The planarization layer 175 may be disposed on the plurality of color filters 170 and the first, second, and third neutral color filters 171, 172, and 173. The planarization layer 175 may have a monolayer structure or a multilayer structure including, for example, silicon oxide, silicon nitride, a photosensitive organic material, or a low dielectric constant (low K) insulating material such as a-Si:C:O or a-Si:O:F.

A contact hole 185 through which at least a portion of the drain electrode 166 is exposed may be formed in the protection layer 169, the color filter 170, and the planarization layer 175. For example, an end portion of the drain electrode 166 disposed below the pixel electrode 180 may be exposed by the contact hole 185,

The pixel electrode 180 electrically connected to the drain electrode 166 through the contact hole 185 may be disposed on the planarization layer 175. The pixel electrode 180 may be formed of a transparent conductive material such as ITO or IZO.

The light shielding member 190 may be disposed on the planarization layer 175. The light shielding member 190 may include a first light shielding member 191 extending along the thin film transistor Q and the gate line 122 and a second light shielding member 193 extending along the data line 162.

The light shielding member 190 may serve to prevent light supplied from a backlight unit (not illustrated) from being transmitted externally, and prevent external light from being irradiated on the layer structure 120 including the thin film transistor Q.

Referring to FIG. 4, a display device according to another exemplary embodiment may include a shield electrode 173, in lieu of the second light shielding member 193.

The shield electrode 173 may be disposed on the first, second, and third neural color filters 171, 172, and 173 to overlap the data line 162.

The shield electrode 173 may serve to prevent the visibility of the data line 162. In other words, light may be shielded through an electric field without using an additional light shielding member by allowing a potential of the shield electrode 173 to be substantially the same as a potential of the common electrode 220.

The shield electrode 173 may be disposed to elongatedly extend along the data line 162, and may have a width greater than that of the data line 162.

The shield electrode 173 may serve to prevent light supplied from a backlight unit (not illustrated) from being transmitted externally, and prevent external light from being irradiated on the data line 162.

Although not illustrated, the display device according to the exemplary embodiment may further include a column spacer maintaining an interval between the lower panel 100 and the upper panel 200. Such a column spacer may be formed to be integrated with the light shielding member 190.

The light shielding member 190 may include a negative or positive photoresist, a black pigment, a black resin, or the like.

Although not illustrated, a lower alignment layer may be disposed on the pixel electrode 180 and the light shielding member 190. The lower alignment layer may be a homeotropic layer and may be an alignment layer including a photo-reactive material.

The lower alignment layer may be formed of one of the following materials: polyamic acid, polysiloxane, and polyimide.

The upper panel 200 may include an upper substrate 210 and the common electrode 220. The upper substrate 210 may include an insulating substrate formed of transparent glass, plastic, or the like. The common electrode 220 may be formed of a transparent conductive material such as ITO, IZO, or the like.

Although not illustrated, the upper panel 200 may further include an upper alignment layer. The upper alignment layer may be disposed on the common electrode 220. The upper alignment layer may be formed of the same material forming the aforementioned lower alignment layer.

When surfaces of the lower substrate 110 and the upper substrate 210 facing one another are defined as upper surfaces of the lower substrate 100 and the upper substrate 210, respectively, and surfaces of the lower substrate 110 and the upper substrate 210 disposed opposite thereto are defined as lower surfaces of the lower substrate 100 and the upper substrate 210, respectively, an upper polarizer may further be disposed on the lower surface of the lower substrate 110 and a lower polarizer may further be disposed on the lower surface of the upper substrate 210.

The liquid crystal layer 300 may include nematic liquid crystal materials having positive dielectric anisotropy. The nematic liquid crystal materials of the liquid crystal layer 300 may have a structure in which a longitudinal direction thereof is parallel to one of the lower panel 100 and the upper panel 200 and the direction is twisted at an angle of 90 degrees in a spiral shape from a rubbing direction of the alignment layer to the upper panel 200. Alternatively, the liquid crystal layer 300 may include homeotropic liquid crystal materials, in lieu of the nematic liquid crystal materials.

The display device according to the exemplary embodiment may increase the luminance thereof by disposing a color filter having a neutral color between adjacent color filters on a data line, thus enhancing the readability thereof.

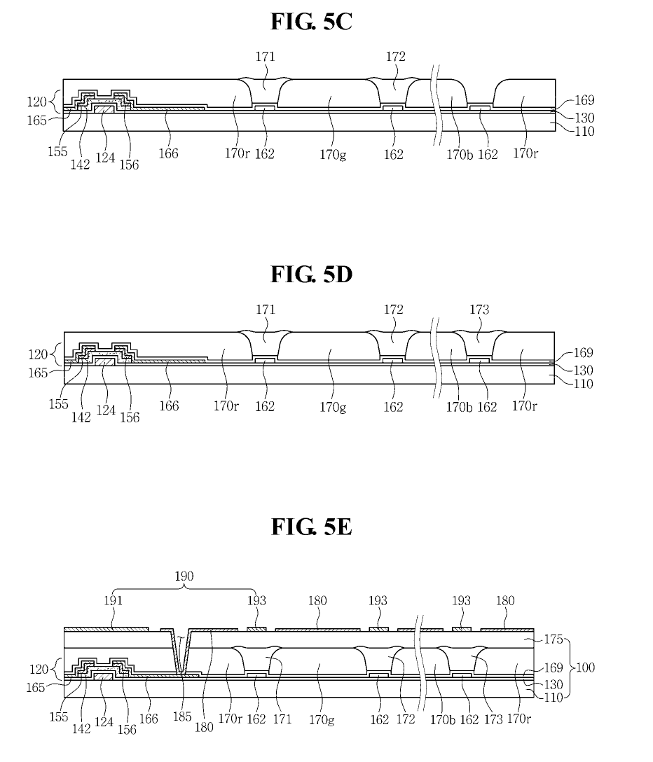

FIGS. 5A through 5E are cross-sectional views illustrating sequential processes of a method of manufacturing a display device according to an exemplary embodiment, respectively.

Referring to FIG. 5A, the red color filter 170r, the green color filter 170g, and the blue color filter 170b may be formed on the lower substrate 110 on which the thin film transistor Q is formed and spaced apart from one another. The red color filter 170r, the green color filter 170g, and the blue color filter 170b may be formed on an area other than the data line 162. The red color filter 170r, the green color filter 170g, and the blue color filter 170b may be formed through a mask process, a photolithography process, an inkjet process, or the like.

Referring to FIG. 5B, the first neutral color filter 171 extending in parallel to the data line 162 may be formed between the red color filter 170r and the green color filter 170g. The first neutral color filter 171 may be formed to have chromaticity coordinates (x, y) in a range of about (0.38˜0.48, 0.46˜0.56) in the CIE xy chromaticity diagram. The first neutral color filter 171 may be formed to have an edge portion thereof overlapping one of the red color filter 170r and the green color filter 170g that are adjacent to one another.

The first neutral color filter 171 may be formed through a mask process, a photolithography process, an inkjet process, or the like.

Referring to FIG. 5C, the second neutral color filter 172 extending in parallel to the data line 162 may be formed between the green color filter 170g and the blue color filter 170b. The second neutral color filter 172 may be formed to have chromaticity coordinates (x, y) in a range of about (0.16˜0.17, 0.30˜0.40) in the CIE xy chromaticity diagram. The second neutral color filter 172 may be formed to have an edge portion thereof overlapping one of the green color filter 170g and the blue color filter 170b that are adjacent to one another.

The second neutral color filter 172 may be formed through a mask process, a photolithography process, an inkjet process, or the like.

Referring to FIG. 5D, the third neutral color filter 173 extending in parallel to the data line 162 may be formed between the blue color filter 170b and the red color filter 170r. The third neutral color filter 173 may be formed to have chromaticity coordinates (x, y) in a range of about (0.34˜0.44, 0.13˜0.23) in the CIE xy chromaticity diagram. The third neutral color filter 173 may be formed to have an edge portion thereof overlapping one of the blue color filter 170b and the red color filter 170r, which are adjacent to one another.

The third neutral color filter 173 may be formed through a mask process, a photolithography process, an inkjet process, or the like.

Referring to FIG. 5E, the planarization layer 175 may be formed on the formation of the color filter 170 and the first, second, and third neutral color filters 171, 172, and 173, and the pixel electrode 180 and the light shielding member 190 may be formed thereon.

The light shielding member 190 may be formed simultaneously with a color spacer (not illustrated), and may be formed to include a negative or positive photoresist, a black pigment, a black resin, or the like.

As set forth above, according to one or more exemplary embodiments, the display device may increase the luminance thereof by disposing the color filter having the neutral color between the adjacent color filters on the data line, thus enhancing the readability of the display device.

From the foregoing, it will be appreciated that various embodiments in accordance with the present disclosure have been described herein for purposes of illustration, and that various modifications may be made without departing from the scope and spirit of the present disclosure. Accordingly, the various exemplary embodiments disclosed herein are not intended to be limiting of the true scope and spirit of the present disclosure. Various features of the above described and other exemplary embodiments can be mixed and matched in any manner, to produce further exemplary embodiments consistent with the present disclosure.

What is claimed is:

1. A display device comprising:
a lower substrate including red, green, and blue pixel units;
an upper substrate disposed opposite to the lower substrate;
a liquid crystal layer interposed between the lower substrate and the upper substrate;
a gate line and a data line disposed on the lower substrate;
a thin film transistor connected to the gate line and the data line;
red, green, and blue color filters disposed on the red, green, and blue pixel units on the thin film transistor, respectively, to be spaced apart from one another;
a neutral color filter interposed between the red, green, and blue color filters and extending along the data line; and
a pixel electrode disposed on the red, green, and blue color filters.

2. The display device of claim 1, wherein the neutral color filter includes:
a first neutral color filter interposed between the red color filter and the green color filter;
a second neutral color filter interposed between the green color filter and the blue color filter; and
a third neutral color filter interposed between the blue color filter and the red color filter.

3. The display device of claim 2, wherein the first neutral color filter has a neutral color between the red color of the red color filter and the green color of the green color filter.

4. The display device of claim 2, wherein the second neutral color filter has a neutral color between the green color of the green color filter and the blue color of the blue color filter.

5. The display device of claim 2, wherein the third neutral color filter has a neutral color between the blue color of the blue color filter and the red color of the red color filter.

6. The display device of claim 3, wherein the first neutral color filter has chromaticity coordinates (x, y) in a range of about (0.38˜0.48, 0.46˜0.56) in a CIE xy chromaticity diagram.

7. The display device of claim 4, wherein the second neutral color filter has chromaticity coordinates (x, y) in a range of about (0.16˜0.17, 0.30˜0.40) in the CIE xy chromaticity diagram.

8. The display device of claim 5, wherein the third neutral color filter has chromaticity coordinates (x, y) in a range of about (0.34˜0.44, 0.13˜0.23) in the CIE xy chromaticity diagram.

9. The display device of claim 1, further comprising a planarization layer disposed on the red, green, and blue color filters and the neutral color filter.

10. The display device of claim 9, further comprising a first light shielding member disposed on the planarization layer and extending along the gate line.

11. The display device of claim 10, further comprising a second light shielding member disposed on the planarization layer and extending along the data line.

12. The display device of claim 10, further comprising a shield electrode disposed on the neutral color filter and extending along the data line.

13. A method of manufacturing a display device, the method comprising:
forming a thin film transistor on a lower substrate including red, green, and blue pixel units;
forming red, green, and blue color filters to correspond to the red, green, and blue pixel units on the thin film transistor, respectively, to be spaced apart from one another;
forming a neutral color filter interposed between the red, green, and blue color filters; and
forming a pixel electrode on the red, green, and blue color filters.

14. The method of claim 12, wherein the forming of the neutral color filter includes:
forming a first neutral color filter between the red color filter and the green color filter;
forming a second neutral color filter between the green color filter and the blue color filter; and
forming a third neutral color filter between the blue color filter and the red color filter.

15. The method of claim 13, wherein the first neutral color filter is formed to have chromaticity coordinates (x, y) in a range of about (0.38˜0.48, 0.46˜0.56) in a CIE xy chromaticity diagram.

16. The method of claim 13, wherein the second neutral color filter is formed to have chromaticity coordinates (x, y) in a range of about (0.16˜0.17, 0.30˜0.40) in the CIE xy chromaticity diagram.

17. The method of claim 13, wherein the third neutral color filter is formed to have chromaticity coordinates (x, y) in a range of about (0.34˜0.44, 0.13˜0.23) in the CIE xy chromaticity diagram.
